(19) United States
(12) Patent Application Publication
(10) Pub. No.: US 2004/0107521 A1
(43) Pub. Date: Jun. 10, 2004

(54) Electric toothbrushes

(75) Inventors: John Geoffrey Chan, Loveland, OH (US); Wang Ping, Beijing (CN)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/313,856

(22) Filed: Dec. 6, 2002

(51) Int. Cl. A61C 17/34

(52) U.S. Cl. 15/28; 15/22.1; 15/167.1; 15/DIG. 5

(57) ABSTRACT

An electric toothbrush is provided. The electric toothbrush includes a housing, a brush head, and a neck extending between the housing and the brush head. The housing has a hollow interior. A movable bristle carrier is disposed on the brush head. An electric motor is disposed in the hollow interior of the housing, and the motor is operatively connected to the movable bristle carrier to impart a rotating or oscillating motion thereto. A first plurality of tufts are arranged in a first ring of the movable bristle carrier, each of the first plurality of tufts has a plurality of first bristles. A second plurality of tufts is arranged in a second ring inside of the first ring. Each of the second plurality of tufts has a plurality of second bristles, wherein at least some of the second plurality of tufts have a diameter that is greater than a diameter of at least some of the first plurality of tufts.

### FIELD OF THE INVENTION

The present invention relates to electric toothbrushes having one or more movable bristle carriers and bristle arrangements therefor.

### BACKGROUND OF THE INVENTION

Electric toothbrushes have utilized a wide array of bristle arrangements. For toothbrushes that employ a bristle carrier that rotates or oscillates about a center or other fixed location on a brush head, the bristles on such carrier may be arranged in one or more circular rows such as shown in U.S. Pat. Nos. 5,652,990 and 6,021,538. Those patents describe bristle arrangements in which the bristles are arranged in circular rows that extend along a face of the bristle carrier. Additionally, those patents describe certain combinations of bristle diameters and lengths and certain bristle tuft characteristics that are said to provide improved cleaning action.

Although satisfactory in many respects, a need still exists for improved bristle configurations for a movable bristle carrier for an electric toothbrush. Furthermore, there is a need for improved bristle configurations that can provide improved inter-proximal cleaning and/or which can provide improved mouth feel with fewer tufts.

### SUMMARY OF THE INVENTION

An electric toothbrush is provided. The electric toothbrush includes a housing, a brush head, and a neck extending between the housing and the brush head. The housing has a hollow interior. A movable bristle carrier is disposed on the brush head. An electric motor is disposed in the hollow interior of the housing, and the motor is operatively connected to the movable bristle carrier to impart a rotating or oscillating motion thereto. A first plurality of tufts are arranged in a first ring of the movable bristle carrier, each of the first plurality of tufts has a plurality of first bristles. A second plurality of tufts is arranged in a second ring inside of the first ring. Each of the second plurality of tufts has a plurality of second bristles, wherein at least some of the second plurality of tufts have a diameter that is greater than a diameter of at least some of the first plurality of tufts.

### BRIEF DESCRIPTION OF THE DRAWINGS

It is believed that the present invention will be better understood from the following description taken in conjunction with the accompanying drawings in which:

FIG. 1 is a perspective view of a first preferred embodiment toothbrush having a preferred brush head according to the present invention;

FIG. 2 is a partial top view of the toothbrush of FIG. 1;

FIG. 3 is a partial perspective view of a toothbrush illustrating another preferred brush head according to the present invention;

FIG. 4 is a top view of the toothbrush of FIG. 3;

FIG. 5 is a top view of yet another preferred embodiment brush head according to the present invention;

FIG. 6 is a perspective view of a preferred embodiment bristle carrier according to the present invention; and

FIG. 7 is a perspective view of another preferred embodiment bristle carrier according to the present invention

### DETAILED DESCRIPTION OF THE PREFERRED EMBODIMENTS

Each of the patents and patent applications referenced in this specification are hereby fully incorporated herein by reference. The present invention will now be described with reference to the figures in which reference numeral having the same last two digits (e.g., 10, 110) connote similar elements between the views. The present invention provides various brush head configurations and bristle arrangements particularly adapted for use with an electric toothbrush. The preferred brush head configurations utilize a plurality of concentrically arranged rings of tufts of bristles. Most preferably, the preferred embodiment bristle arrangements comprise two rings of tufts, an outer ring and an inner ring. The bristle arrangements may optionally contain an open interior, or rather a center region that is free of a tuft of bristles.

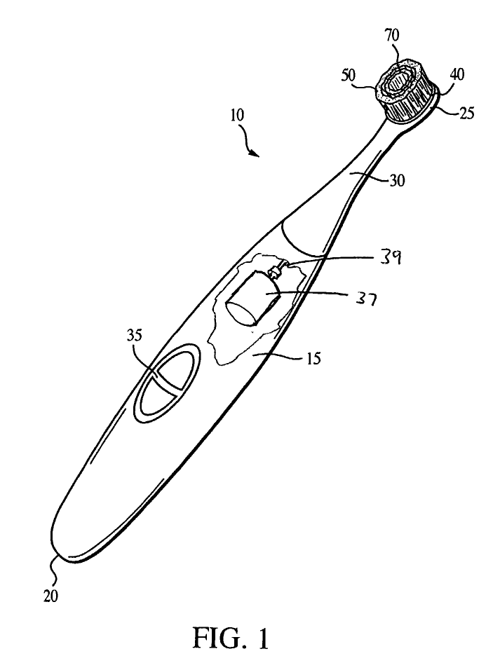

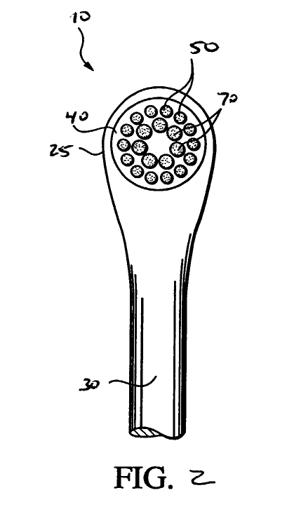

FIGS. 1 and 2 illustrate a preferred embodiment electric toothbrush 10 according to the present invention. The preferred embodiment electric toothbrush comprises a hollow body or housing 15 having a base 20 and a brush head 25 opposite the base 20. A neck 30 extends between the body 15 and the brush head 25. Movably disposed on the brush head 25 is a first movable bristle carrier 40. In one embodiment, the first movable bristle carrier 40 is located at a first end distal from the base 20. However, it is contemplated that the first bristle carrier 40 could located elsewhere on the brush head 25. Disposed on the first movable bristle carrier 40 are a plurality of bristles grouped or arranged in tufts. The tufts are preferably formed into two concentric rings. The preferred arrangement includes a first or outer ring of tufts 50 and a second or inner ring of tufts 70. The preferred embodiment electric toothbrush 10 further includes a switch 35 for activating an electric motor 37 disposed within the body 15 or a hollow region thereof as known in the art. The electric motor is operatively connected to the first movable bristle carrier 40 by a drive mechanism that moves the first movable bristle carrier 40. The drive mechanism can include a shaft 39 or a shaft and gearing assembly (not shown). The shaft 39 can rotate, oscillate, or vibrate. The bristle carrier 40, when powered, can oscillate or rotate about its center or point of attachment to the brush head 25 such that the first bristle carrier 40 rotates or oscillates about an axis that is substantially perpendicular to a longitudinal axis the brush head 25. An “oscillating” motion as used herein refers to rotary motion by a bristle carrier in which the carrier is rotated about its point of attachment to the brush head, i.e. its center point, in one direction, generally through an arc of less than 360°, and then rotated in the opposite direction, again, generally through an arc of less than 360°. This cycle is repeated. Details about some suitable drive mechanisms, motion types, and movable bristle carriers, are contained in one or more of the following U.S. patents and/or publications: U.S. Pat. Nos. 6,000,083; 6,178,579; 6,189,693; 6,360,395; 6,371,294; 5,625,916; 5,617,603; 5,974,615; 6,032,313; 5,732,432; 5,070,567; 5,170,525; and 5,867,856.

In accordance with one aspect of the present invention, the diameter of at least some of the tufts 70 of the inner ring are greater than the diameter of at least some of the tufts 50 of the outer ring, as best seen in FIG. 2. In addition, in another embodiment, at least some of the tufts 70 of the inner ring have bristles with a diameter greater than or equal to the diameter of at least some of the bristles of the tufts 50 of the outer ring. In yet another embodiment, all of the bristles of the tufts 70 have a diameter that is greater than or equal to the diameter of all of the bristles of the tufts 50 of the outer ring. In still another embodiment, or optionally in combination with one or more of the foregoing bristle arrangements, the bristles of the tufts 70 of the inner ring all have bristle diameters that are at least as large as the largest diameter of the bristles of the tufts 50 of the outer ring. Given that the tuft diameters are generally larger on the inner ring than the outer ring, the number of bristles per tuft may be greater for the inner ring than the outer ring for tufts with bristles having the same bristle diameter.

In combination with any of the above-described bristle arrangements, the diameter of the bristles of the tufts 50 may also alternate between adjacent tufts 50 of the outer ring. For example, one tuft 50 might have all bristles of a first diameter while adjacent tufts 50 (i.e., the tufts 50 on either side of the one tuft 50) on the outer ring each have bristles of a second diameter, wherein the second diameter is greater than the first diameter and this pattern repeats throughout the outer ring. In a preferred embodiment, the tufts 50 of the outer ring have bristles that are 7 mils in diameter and the next or adjacent tufts 50 have bristles that are 6 mils in diameter. This pattern repeats around the circumference of the outer ring. An alternate arrangement includes a variation in which one tuft 50 of the outer ring contains bristles that are 5 mils in diameter and the next or adjacent tufts 50 in the outer ring contains bristle that are 6 mils or 7 mils in diameter. This pattern repeats around the circumference of the ring. And, it is contemplated to provide an arrangement in which one tuft of bristles of the outer ring contains bristles of 5 mils diameter, the next or adjacent tuft in this same ring contains bristles that are 6 mils diameter, and the next or adjacent tuft in this same ring contains bristles that are 7 mils diameter. This pattern also repeats around the circumference of the ring.

As best seen in FIG. 2, the tufts that form the inner ring are arranged such that each tuft of the inner ring is disposed between two adjacent tufts of the outer ring. In other words, a line passing through the center of an inner tuft (e.g., a tuft 70) and through the center of any outer tuft (e.g., a tuft 50) does not lie on a diameter of the first bristle carrier (e.g., a carrier 40).

Table 1, set forth below, further illustrates particularly preferred combinations of bristle diameter and number of bristles per tuft in both the outer ring and inner ring of additional preferred embodiment brush head configurations of the present invention.

TABLE 1
Preferred Combinations of Bristle Diameter and Number of Bristles Per Tuft

| | OUTER RING | | | | | | INNER RING | |
|---|---|---|---|---|---|---|---|---|
| | Bristle Dia. = 5 | | Bristle Dia. = 6 | | Bristle Dia. = 7 | | Bristle Dia. = 6 | |
| | mils | | mils | | mils | | mils | |
| | Bristles Per Tuft | | Bristles Per Tuft | | Bristles Per Tuft | | Bristles Per Tuft | |
| | | Most | | Most | | Most | | Most |
| Embodiment | Pref. | Pref. | Pref. | Pref. | Pref. | Pref. | Pref. | Pref. |
| A | — | — | 24-28 | 26 | — | — | 30-34 | 32 |
| B | — | — | 24-28 | 26 | 17-21 | 19 | 30-34 | 32 |
| C | — | — | 24-28 | 26 | 17-21 | 19 | — | — |
| D | 31-37 | 34 | 24-28 | 26 | — | — | 30-34 | 32 |
| E | 31-37 | 34 | 24-28 | 26 | — | — | 30-34 | 32 |
| F | — | — | 24-28 | 26 | 17-21 | 19 | — | — |

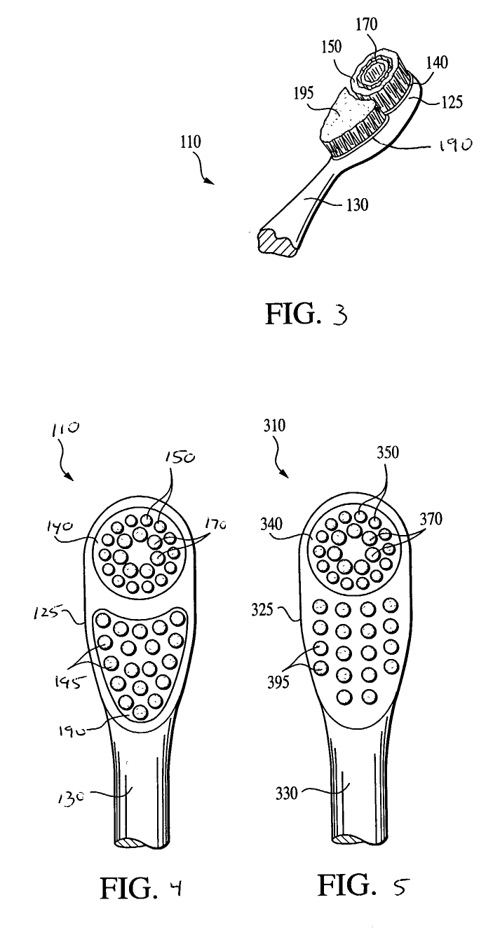

The bristle configuration described above with respect to FIG. 1 can also be 10 combined with other bristle arrangements as described hereafter with respect to FIGS. 3 to 5. FIGS. 3 and 4 illustrate another preferred embodiment electric toothbrush 110 and its preferred brush head according to the present invention. In this preferred toothbrush 110, a brush head 125 is provided that includes both a first movable bristle carrier 140 in combination with a second movable bristle carrier 190. Disposed on the first movable bristle carrier 140 are a collection of bristles grouped or arranged in tufts 150 and 170, the same as previously described for electric toothbrush 10, and arranged in an outer ring and an inner ring, respectively. Disposed on the second movable bristle carrier 190 are a second collection of bristles grouped or arranged in tufts 195. The second movable bristle carrier 190 may undergo a wide range of motions including but not limited to, rotary, oscillating, reciprocating, translating, pulsating, and combinations thereof. Some of these motions are described in U.S. patent application Ser. No. 09/993,167 filed Nov. 6, 2001.

FIG. 5 illustrates another preferred embodiment electric toothbrush 310 in accordance with the present invention. This preferred embodiment toothbrush 310 comprises a brush head 325 extending from a neck 330. The preferred embodiment toothbrush 310 includes a movable bristle carrier 340 disposed on or proximate to the terminal end of the brush head 325. A collection of static or fixed bristles grouped or arranged into tufts 395 are provided on the brush head 325. These static bristles can be variously arranged but are shown for simplicity as disposed between the first movable bristle carrier 340 and a neck 330. The static bristles are anchored in the head 325 (or a sub-structure thereof) such that they are not operatively connected to the shaft (not shown) that moves the first bristle carrier 340. Disposed on the movable bristle carrier 340 is a collection of bristles grouped or arranged into tufts 350 and 370 arranged in a concentric ring pattern as previously described.

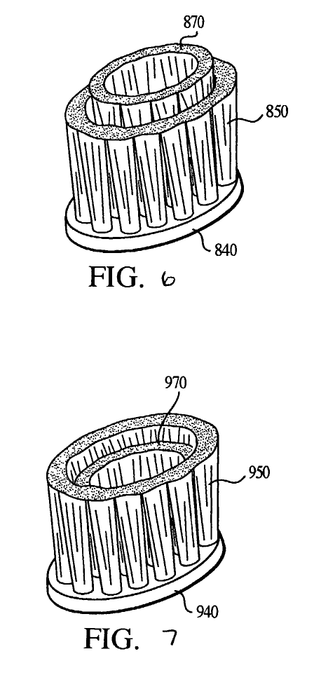

It is also contemplated to provide the outer ring or inner ring of bristles in the preferred embodiment toothbrushes with a relatively short height, tall height, or a height that is different than that of bristles in the other ring. FIG. 6 is a perspective view of a first movable bristle carrier 840 in accordance with the present invention for use in yet another preferred embodiment toothbrush. In this configuration, it can be seen that the tufts 850 of the outer ring are shorter or have a height that is less than that of the tufts 870 forming the inner ring. FIG. 7 is a perspective view of yet another first bristle carrier 940 of a preferred embodiment toothbrush in accordance with the present invention. In this embodiment, the tufts 950 forming the outer ring 950 have a height that is greater than the tufts 970 forming an inner ring. Details as to the composition, processing, and manufacturing relating to bristles and the organization of bristles into bristle tufts are provided in one or more of the following patents: U.S. Pat. No. 5,165,761; WO 96/02165; WO 96/16571; WO 98/05241; WO 98/05239; U.S. Pat. No. 6,115,870; WO 00/76369; and U.S. Pat. No. 6,314,605.

It will be noted that in all of the preferred embodiments described herein, the various concentric ring bristle patterns do not contain any bristles within the inner or center region of the pattern. These patterns are referred to herein as “bristle free center ring patterns.” Although the preferred concentric ring patterns have a bristle free center, the present invention includes electric toothbrushes utilizing bristle carriers with concentric rings of bristles and one or more bristles or tufts of bristles disposed within the inner or at center region of the bristle carrier. Further, more than two concentric rings of tufts of bristle can be provided. While the rings of tufts are shown herein as concentric, it will be appreciated that rings of tufts that are not concentric can also be provided. The present invention may be provided with nearly any number of rings. Although two (2) ring patterns are described herein, the present invention includes patterns of 3, 4, 5, and 6 or more rings. Most preferably, these rings are concentrically arranged.

Any or all of the foregoing features or aspects of any of the preferred embodiments described herein may be provided in combination with any other feature(s) or aspect(s) of any other preferred embodiment described herein. Further it is contemplated that various changes and modifications apparent to those skilled in the art, may be made without departing from the present invention. Therefore, the foregoing description is intended to cover all such changes and modifications encompassed within the spirit and scope of the present invention, including all equivalent aspects.

What is claimed is:

1. An electric toothbrush comprising:
a housing, a brush head, and a neck extending between said housing and said brush head, said housing defining a hollow interior;
a movable bristle carrier disposed on said brush head;
a motor disposed in said hollow interior of said housing, said motor operatively connected to said movable bristle carrier to impart oscillating motion thereto; and
a first plurality of tufts arranged in a first ring on said movable bristle carrier, each of said first plurality of tufts comprising a plurality of first bristles;
a second plurality of tufts arranged in a second ring inside of said first ring on said movable bristle carrier, each of said second plurality of tufts comprising a plurality of second bristles; wherein at least some of said second plurality of tufts have a diameter that is greater than a diameter of at least some of said first plurality of tufts.

2. The electric toothbrush of claim 1, wherein said first and second rings are concentric.

3. The electric toothbrush of claim 1, wherein at least some of said second bristles have a diameter equal to or greater than the largest diameter of said first bristles.

4. The electric toothbrush of claim 3, wherein said second bristles have a diameter between about 6 mils and about 8 mils.

5. The electric toothbrush of claim 4, wherein at least some of said second plurality of tufts have between about 20 and about 40 of said second bristles per tuft.

6. The electric toothbrush of claim 3, wherein said first bristles have a diameter between about 4 mils and about 8 mils.

7. The electric toothbrush of claim 6, wherein at least some of said first plurality of tufts have between about 10 and about 40 of said first bristles per tuft.

8. The electric toothbrush of claim 1, wherein at least some of said plurality of second tufts either (i) contains from about 30 to about 34 second bristles having a diameter of 6 mils, or (ii) contains from about 21 to about 25 bristles having a diameter of 7 mils, and at least some of said plurality of first tufts either (iii) contains from about 31 to about 37 first bristles having a diameter of 5 mils, (iv) contains from about 24 to about 28 first bristles having a diameter of 6 mils, or (v) contains from about 17 to about 21 first bristles having a diameter of 7 mils.

9. The electric toothbrush of claim 3, wherein said first bristles of one of said first tufts have a diameter that is greater than said first bristles of an adjacent first tuft.

10. The electric toothbrush of claim 9, wherein said first bristles of said one of said first tufts have a diameter of 6 mils and said first bristles of said adjacent first tuft have a diameter of 7 mils.

11. The electric toothbrush of claim 1, wherein all of said second plurality of tufts have a diameter greater than the largest diameter of said first plurality of tufts.

12. An electric toothbrush, comprising:
a housing, a brush head, and a neck extending between said housing and said brush head, said housing defining a hollow interior;
a movable bristle carrier disposed on said brush head;
a motor disposed in said hollow interior of said housing, said motor operatively connected to said movable bristle carrier to impart oscillating motion thereto; and
a first plurality of tufts arranged in a first ring on said movable bristle carrier, each of said first plurality of tufts comprising a plurality of first bristles;
a second plurality of tufts arranged in a second ring inside of said first ring on said movable bristle carrier, each of said second plurality of tufts comprising a plurality of second bristles; wherein at least some of said second plurality of tufts have a diameter that is greater than a diameter of at least some of said first plurality of tufts; and
wherein at least some of said second bristles have a diameter equal to or greater than the largest diameter of said first bristles.

13. The electric toothbrush of claim 12, wherein said first and second rings are concentric.

14. The electric toothbrush of claim 12, wherein said second bristles have a diameter between about 6 mils and about 8 mils.

15. The electric toothbrush of claim 14, wherein at least some of said second plurality of tufts have between about 20 and about 40 of said second bristles per tuft.

16. The electric toothbrush of claim 12, wherein said first bristles have a diameter between about 4 mils and about 8 mils.

17. The electric toothbrush of claim 16, wherein at least some of said first plurality of tufts have between about 10 and about 40 of said first bristles per tuft.

18. The electric toothbrush of claim 12, wherein at least some of said plurality of second tufts either (i) contains from about 30 to about 34 second bristles having a diameter of 6 mils, or (ii) contains from about 21 to about 25 bristles having a diameter of 7 mils, and at least some of said plurality of first tufts either (iii) contains from about 31 to about 37 first bristles having a diameter of 5 mils, (iv) contains from about 24 to about 28 first bristles having a diameter of 6 mils, or (v) contains from about 17 to about 21 first bristles having a diameter of 7 mils.

19. The electric toothbrush of claim 12, wherein said first bristles of one of said first tufts have a diameter that is greater than said first bristles of an adjacent first tuft.

20. The electric toothbrush of claim 19, wherein said first bristles of said one of said first tufts have a diameter of 6 mils and said first bristles of said adjacent first tuft have a diameter of 7 mils.
